(19) United States
(12) Patent Application Publication
(10) Pub. No.: US 2026/0239371 A1
(43) Pub. Date: Aug. 13, 2026

(54) MECHANISM FOR DATA TRANSMISSION IN FEEDBACK DISABLED HARQ

(71) Applicant: Nokia Technologies Oy, Espoo (FI)

(72) Inventors: Tzu-Chung HSIEH, Hoffman Estates, IL (US); Pingping WEN, Shanghai (CN); Jingyuan SUN, Beijing (CN); Ping YUAN, Beijing (CN)

(21) Appl. No.: 19/471,344

(22) PCT Filed: Apr. 6, 2023
(86) PCT No.: PCT/CN2023/086725

§ 371 Date: Oct. 1, 2025

(51) Int. Cl. H04W 72/231; H04L 1/1812; H04W 72/12

(52) U.S. Cl. CPC H04W 72/231; H04L 1/1812; H04W 72/12

(57) ABSTRACT

The present disclosure relates to a solution on data transmission in feedback disabled hybrid automatic repeat request (HARQ). According to some example embodiments of the present disclosure, a terminal device determines whether data scheduled by DCI is an initial transmission or a retransmission based on a new data indicator (NDI) and a redundancy version in the DCI. In this way, the terminal device is able to determine if the incoming DCI schedules new data or retransmission after missing the previous DCI with a toggled NDI. Further it can avoid subsequent packet error arising from a DCI detection failure when HARQ feedback is disabled.

### FIELDS

Various example embodiments of the present disclosure generally relate to the field of telecommunication and in particular, to methods, devices, apparatuses and computer readable storage medium for data transmission in feedback disabled hybrid automatic repeat request (HARQ).

### BACKGROUND

HARQ (Hybrid Automatic Repeat request) is implemented in a medium access control (MAC) protocol of long-term evolution (LTE) and 5G new radio (NR) for reliable transfer of transport blocks (TBs). For both downlink and uplink, multiple HARQ processes can run in parallel (if supported by a user equipment (UE)). In the case of DL data transmission, the UE sends a one-bit HARQ feedback (for example, ACK or NACK) to report decoding outcome of the TB received in a HARQ process. Based on the feedback, network (NW) may retransmit the previous TB or transmit a new TB for the same HARQ process. In the case of UL data transmission, NW may schedule a new TB or retransmission based on the decoding status of previous transmission in a HARQ process. This stop-and-wait mechanism within a HARQ process allows the receiver at either UE or network device to combine the previously received soft bits with a current retransmission for a more reliable packet decoding.

### SUMMARY

In a first aspect of the present disclosure, there is provided a first device. The first device comprises at least one processor; and at least one memory storing instructions that, when executed by the at least one processor, cause the first device to perform: obtaining a configuration of redundancy version that indicates a first set of redundancy versions used for an initial data transmission and a second set of redundancy versions used for a data retransmission; receiving, from a second device, downlink control information that schedules data and comprises a new data indicator and a redundancy version for the data; determining, based on the new data indicator and the redundancy version, whether the scheduled data is an initial transmission of the data or a retransmission of the data; and processing the data based on the determination.

In a second aspect of the present disclosure, there is provided a second device. The second device comprises at least one processor; and at least one memory storing instructions that, when executed by the at least one processor, cause the second device to perform: obtaining a configuration of redundancy version that indicates a first set of redundancy versions used for an initial data transmission and a second set of redundancy versions used for a data retransmission; and transmitting, to a first device, downlink control information that schedules data and comprises a new data indicator and a redundancy version for the data, wherein whether the scheduled data is an initial transmission of the data or a retransmission of the data is indicated with a combination of the new data indicator and the redundancy version.

In a third aspect of the present disclosure, there is provided a method. The method comprises: obtaining, at a first device, a configuration of redundancy version that indicates a first set of redundancy versions used for an initial data transmission and a second set of redundancy versions used for a data retransmission; receiving, from a second device, downlink control information that schedules data and comprises a new data indicator and a redundancy version for the data; determining, based on the new data indicator and the redundancy version, whether the scheduled data is an initial transmission of the data or a retransmission of the data; and processing the data based on the determination.

In a fourth aspect of the present disclosure, there is provided a method. The method comprises: obtaining, at a second device, a configuration of redundancy version that indicates a first set of redundancy versions used for an initial data transmission and a second set of redundancy versions used for a data retransmission; and transmitting, to a first device, downlink control information that schedules data and comprises a new data indicator and a redundancy version for the data, wherein whether the scheduled data is an initial transmission of the data or a retransmission of the data is indicated with a combination of the new data indicator and the redundancy version.

In a fifth aspect of the present disclosure, there is provided a first apparatus. The first apparatus comprises means for obtaining a configuration of redundancy version that indicates a first set of redundancy versions used for an initial data transmission and a second set of redundancy versions used for a data retransmission; means for receiving, from a second device, downlink control information that schedules data and comprises a new data indicator and a redundancy version for the data; means for determining, based on the new data indicator and the redundancy version, whether the scheduled data is an initial transmission of the data or a retransmission of the data; and means for processing the data based on the determination.

In a sixth aspect of the present disclosure, there is provided a second apparatus. The second apparatus comprises means for obtaining a configuration of redundancy version that indicates a first set of redundancy versions used for an initial data transmission and a second set of redundancy versions used for a data retransmission; and means for transmitting, to a first device, downlink control information that schedules data and comprises a new data indicator and a redundancy version for the data, wherein whether the scheduled data is an initial transmission of the data or a retransmission of the data is indicated with a combination of the new data indicator and the redundancy version.

In a seventh aspect of the present disclosure, there is provided a non-transitory computer readable medium. The non-transitory computer readable medium comprising program instructions that, when executed by an apparatus, cause the apparatus to perform the method according to the third aspect.

In an eighth aspect of the present disclosure, there is provided a non-transitory computer readable medium. The non-transitory computer readable medium comprising program instructions that, when executed by an apparatus, cause the apparatus to perform the method according to the fourth aspect.

In a ninth aspect of the present disclosure, there is provided a computer program. The computer program comprising instructions which, when executed by an apparatus, cause the apparatus to perform the method according to the third aspect.

In a tenth aspect of the present disclosure, there is provided a computer program. The computer program comprising instructions which, when executed by an apparatus, cause the apparatus to perform the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates a schematic diagram of a scenario where new data indicator (NDI) out of synchronization;

FIG. 2 illustrates an example communication environment in which example embodiments of the present disclosure can be implemented;

FIG. 3 illustrates a signaling chart for communication according to some example embodiments of the present disclosure;

FIG. 4 illustrates a schematic diagram of redundancy versions;

FIG. 5A illustrates a schematic diagram of new data transmission after NDI state becomes out of synchronization according to some example embodiments of the present disclosure;

FIG. 5B illustrates a schematic diagram of a data retransmission after NDI state becomes out of synchronization according to some example embodiments of the present disclosure;

FIG. 6A illustrates a flowchart of a downlink (DL) HARQ processing at a terminal device according to some example embodiments of the present disclosure;

FIG. 6B illustrates a flowchart of an uplink (UL) HARQ processing at a terminal device according to some example embodiments of the present disclosure;

FIG. 7 illustrates a flowchart of a method implemented at a first device according to some example embodiments of the present disclosure;

FIG. 8 illustrates a flowchart of a method implemented at a second device according to some example embodiments of the present disclosure;

FIG. 9 illustrates a simplified block diagram of a device that is suitable for implementing example embodiments of the present disclosure; and

FIG. 10 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An TAB node comprises a Mobile Terminal (IAB-MT) part that behaves like a UE toward the parent node, and a DU part of an TAB node behaves like a base station toward the next-hop TAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an TAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

With Incremental Redundancy, retransmitted packets related to the same information bits although each packet carries a different subset of information and parity bits. Exactly what goes into each transmission is determined by 5G NR's rate matching functionality. Each transmission refers to a “Redundancy Version (RV)”. The redundancy version determines which bits are selected for transmission, and different RVs will result in different sets of bits being sent. The term “new data indicator (NDI)” used herein may refer to an indication that is used to determine if a received TB is a new transmission or a retransmission. When NDI is toggled in downlink control information, it implies new downlink data. Toggling NDI in uplink grant informs UE to send new data. The term “downlink control information (DCI)” used herein may refer to a dynamic physical layer control message from the network to UE. The term “hybrid automatic repeat request (HARQ)” used herein may refer to a combination of high-rate forward error correction (FEC) and automatic repeat request (ARQ) error-control. The term “HARQ process” may refer to a stop-and-wait process that is used to transmit data. Each HARQ process has an independent HARQ buffer. The HARQ process can be identified by a HARQ process identity (ID). Each HARQ process may store a NDI value. The term “transport block (TB)” used herein may refer to a packet of data.

As mentioned above, HARQ has been introduced to improve communication reliability. However, in a non-terrestrial network (NTN), due to the long distance between the satellite and UE, a signal round-trip time (RTT) is much longer than in a terrestrial network (e.g., 25.77 ms for low earth orbit (LEO) at 600 km, 541.46 ms for geostationary orbit (GEO)). For simple internet of thing (IoT) devices with few HARQ processes, data transmissions in parallel HARQ processes may not fill up the RTT, resulting in the blockage of continuous transmission because all HARQ processes are occupied waiting for response from the transmitter. This “HARQ stalling” problem will impact the achievable user throughput and is to be addressed by disabling HARQ feedback for IoT over NTN. For example, in order to enhance IoT-NTN performance, it may consider existing IoT-NTN as baseline as well as other study outcome and the further IoT-NTN performance enhancements objectives are listed below: disabling of HARQ feedback to mitigate impact of HARQ stalling on UE data rates.

The following Table 1 shows the impact of HARQ stalling and potential gain if HARQ feedback is disabled, considering the deployment scenarios of GEO, LEO at 1200 km, and LEO at 600 km for NTN. The throughput gain is a result of not waiting for retransmission and saving of HARQ feedback transmission time in case of half-duplex UE. Table 1 shows DL throughput (in kbps) comparison when HARQ feedback is enabled and disabled. Note “Set1” in Table 1 refers to “Set-1 satellite parameters”.

TABLE 1

| Deploy- | Set1, NB-IoT with 2 HARQ processes | | | | | | Set1, NB-IoT with 1 HARQ processes | | | | | |
|---|---|---|---|---|---|---|---|---|---|---|---|---|
| ment | GEO | | LEO1200 | | LEO600 | | GEO | | LEO1200 | | LEO600 | |
| Scenario | Center | Edge | Center | Edge | Center | Edge | Center | Edge | Center | Edge | Center | Edge |
| Unused | 91.1 | 86.9 | 15.4 | 12.1 | 0 | 0 | 95.6 | 93.4 | 57.7 | 56.1 | 43.8 | 42 |
| time period | | | | | | | | | | | | |
| [%] | | | | | | | | | | | | |
| Throughput | 2.4 | 2.3 | 27.4 | 24.9 | 32.4 | 28.3 | 1.2 | 1.2 | 13.7 | 12.5 | 18.2 | 16.4 |
| with | | | | | | | | | | | | |
| feedback | | | | | | | | | | | | |
| [kbps] | | | | | | | | | | | | |
| Throughput | 34 | 20 | 42.5 | 35.8 | 42.5 | 35.8 | 34 | 20 | 42.5 | 35.8 | 42.5 | 35.8 |
| without | | | | | | | | | | | | |
| feedback | | | | | | | | | | | | |
| [kbps] | | | | | | | | | | | | |
| Throughput | 1310.8 | 773.4 | 55.2 | 43.8 | 31.3 | 26.3 | 2733.3 | 1639.1 | 210.4 | 187.5 | 133.4 | 117.8 |
| improvement | | | | | | | | | | | | |
| [%] | | | | | | | | | | | | |

When HARQ feedback is disabled in the DL, the network device has no knowledge of TB decoding outcome, not sure even if the DCI scheduling the TB has been decoded. In a HARQ operation where HARQ feedback (i.e., ACK/NACK bit) is always reported by the UE, the transmitter would know DCI may not have been detected if HARQ feedback is not received. In that case, the transmitter would resend the TB with the same DCI indication for HARQ operation such as NDI, RV, HARQ process ID, modulation coding scheme (MCS), and the like. When HARQ feedback is disabled, however, the network device has no way of knowing DCI not being detected by the UE when it occurs. This could lead to NDI state out of synchronization between the transmitter (the network device) and receiver (UP) and result in decoding failure of subsequent data transmissions.

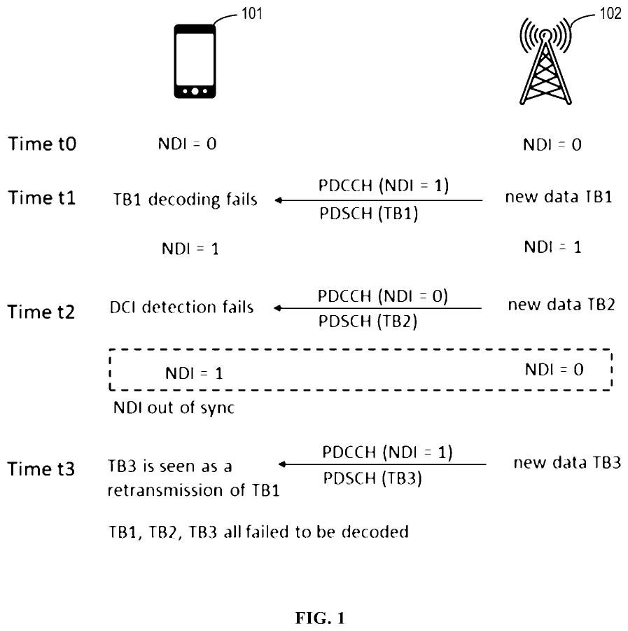

FIG. 1 shows a scenario where data transmissions is performed in a feedback-disabled HARQ process. As shown in FIG. 1, at time t1, new data TB1 is transmitted when the UE 101's DCI state is 0. The DCI is detected but the TB is not decoded successfully. At this point, the UE 101 has updated its NDI state to the value of 1 and has not flushed the soft buffer in order to combine it with later retransmissions. The network device 102 does not know the decoding outcome of TB1 and continues to send another new data TB2 at time t2. The DCI for TB2 has the NDI bit toggled with the value of 0. For this transmission, the UE 101 fails to detect the DCI on the physical downlink control channel (PDCCH) and is unaware of the new incoming data. Its NDI state of that HARQ process remains to be 1. At this point, it can be seen that the NDI state at UE 101 and at the network device 102 is already out of sync, and either side is aware of this error. At time t3, when the network device 120 transmits a new data TB3, the corresponding DCI on PDCCH has the NDI toggled to 1. Suppose the UE 101 detects the DCI this time, the NDI in the DCI appears as untoggled (same as the UE's NDI state for the HARQ process) to the UE 101, and data would be processed as a retransmission of TB1. The received TB3 would be combined with previous TB1 soft bits for decoding, resulting in packet decoding error.

Similar problem is encountered in the UL, where a HARQ process can operate in HARQ mode A or HARQ mode B. In HARQ mode A, scheduling of a UL retransmission always depends on previous PUSCH decoding result. Whereas in HARQ mode B, the retransmission is blindly scheduled by the network device even before the decoding of the previous transmission in case of a long RTT. The problem arises when a DCI for UL transmission is not detected by the UE for a HARQ process running in HARQ mode B. In that scenario, NDI states may be out of sync between the UE and network device since the latter does not wait until the previously transmitted TB has been decoded before scheduling the next transmission. As a result, the UE may perform a retransmission of the previous TB while network device is expecting a new TB, or the UE may transmit a new TB while network device is expecting a retransmission of the previous TB.

This problem can happen to IoT connection over NTN where HARQ feedback can be dynamically disabled to avoid HARQ stalling. The same problem exists as well in NR over NTN where HARQ feedback can be semi-statically disabled via radio resource control (RRC) configuration for a HARQ process. The impact to IoT over NTN is likely to be more significant since transmission of a TB takes a longer time while the satellite connection may last only a few minutes (in case of LEO).

With an aim for the considered problem(s), solution(s) on data transmission in feedback disabled hybrid automatic repeat request (HARQ) is considered. According to some example embodiments of the present disclosure, a terminal device determines whether data scheduled by DCI is an initial transmission or a retransmission based on a new data indicator (NDI) and a redundancy version in the DCI. In this way, the terminal device is able to determine if the incoming DCI schedules new data or retransmission after missing the previous DCI with a toggled NDI. Further it can avoid subsequent packet error arising from a DCI detection failure when HARQ feedback is disabled.

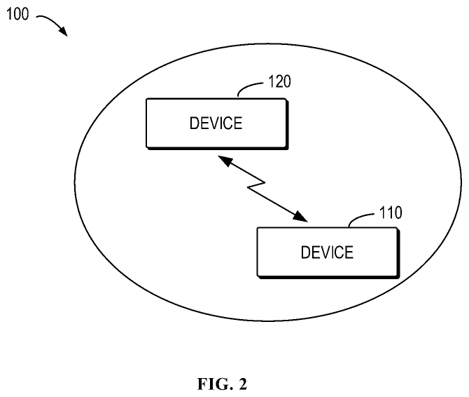

FIG. 2 illustrates an example communication environment 100 in which example embodiments of the present disclosure can be implemented. In the communication environment 100, a plurality of communication devices, including a device 110 and a device 120, can communicate with each other.

In the example of FIG. 2, the device 110 may include a terminal device and the device 120 may include a network device serving the terminal device. The serving area of the device 120 may be called a cell 130.

It is to be understood that the number of devices and their connections shown in FIG. 2 are only for the purpose of illustration without suggesting any limitation. The communication environment 100 may include any suitable number of devices configured to implementing example embodiments of the present disclosure. Although not shown, it would be appreciated that one or more additional devices may be located in the cell 130, and one or more additional cells may be deployed in the communication environment 100. It is noted that although illustrated as a network device, the device 120 may be other device than a network device. Although illustrated as a terminal device, the device 110 may be other device than a terminal device.

In the following, for the purpose of illustration, some example embodiments are described with the device 110 operating as a terminal device and the device 120 operating as a network device. However, in some example embodiments, operations described in connection with a terminal device may be implemented at a network device or other device, and operations described in connection with a network device may be implemented at a terminal device or other device.

In some example embodiments, if the device 110 is a terminal device and the device 120 is a network device, a link from the device 120 to the device 110 is referred to as a downlink (DL), while a link from the device 110 to the device 120 is referred to as an uplink (UL). In DL, the device 120 is a transmitting (TX) device (or a transmitter) and the device 110 is a receiving (RX) device (or a receiver). In UL, the device 110 is a TX device (or a transmitter) and the device 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

Example embodiments of the present disclosure will be described in detail below with reference to the accompanying drawings.

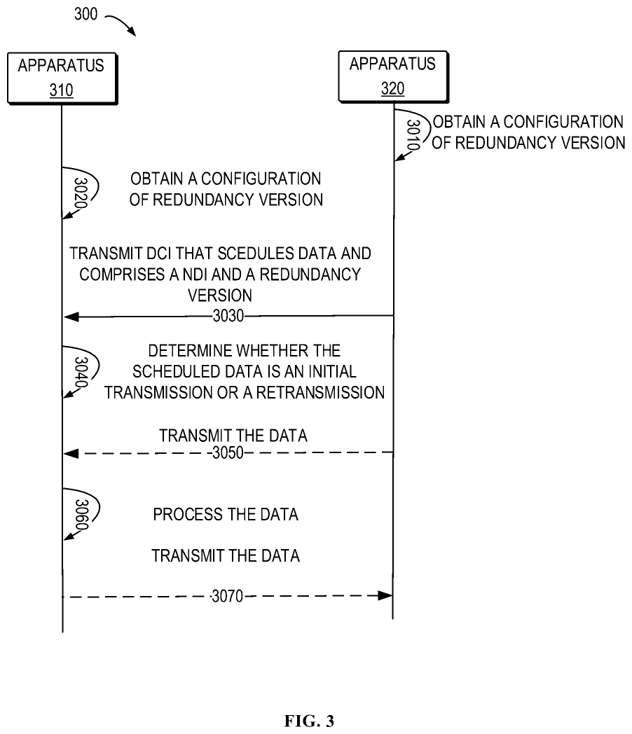

Reference is now made to FIG. 3, which shows a signaling chart 300 for communication according to some example embodiments of the present disclosure. As shown in FIG. 3, the signaling chart 300 involves an apparatus 310 and an apparatus 320. For example, the apparatus 310 may be implemented at the device 110 and the apparatus 320 may be implemented at the device 120.

The apparatus 320 obtains (3010) a configuration of redundancy version (RV). The configuration of RV indicates a first set of RVs used for an initial data transmission and a second set of RVs used for a data retransmission. In some example embodiments, the apparatus 320 may generate the configuration of RV by itself. Alternatively, the configuration of RV may be preconfigured at the apparatus 320.

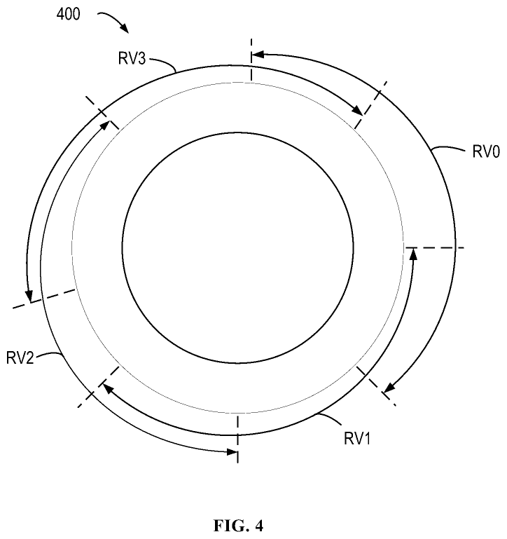

For example, as shown in FIG. 4, transmissions of a transport block over physical downlink shared channel (PDSCH) or physical uplink shared channel (PUSCH) come with four redundancy versions: RV0, RV1, RV2, RV3, corresponding to different starting points in the circular buffer of the encoded bits after channel coding. By way of example, RV0 and RV3 may include some of systematic bits and can be self-decodable, which means that the RV0 and RV 3 can be decoded by itself. By way of example, RV1 and RV2 cannot be decoded by itself, but when combined with other RV, they can facilitate the error correction capability in the decoding process. In some example embodiments, RV(s) in the first set of RVs may be self-decodable. For example, the first set of RVs may include one or more of RV0 or RV3. The first set of RVs and the second set of RVs may not overlap with each other. In other words, if a RV is in the first set of RVs, it cannot be in the second set of RVs, and vice versa. By way of example, the first set of RVs may include RV0 and the second set of RVs may include RV1, RV2, and RV3. It is noted that the RVs shown in FIG. 4 are only examples not limitations. The first set of RVs may include any proper RVs that can be self-decodable. The first set of RVs and the second set of RVs can include any proper numbers of RVs, respectively.

The apparatus 310 obtains (3020) the configuration of RV. In some example embodiments, the apparatus 320 may transmit the configuration of RV to the apparatus 310. In other words, the apparatus 310 may receive the configuration of RV from the apparatus 320. In some example embodiments, the configuration of RV may be transmitted in system information block (SIB). In some other example embodiments, the configuration of RV may be transmitted a RRC message. Alternatively, the configuration of RV may be preconfigured at the apparatus 310. In this case, the configuration of RV may be enabled or disabled by SIB or RRC signaling. For example, if the SIB or RRC message enables the configuration of RV, the apparatus 310 may apply the configuration of RV.

In some example embodiments, the configuration of redundancy version comprises a sequence of the redundancy versions. In this case, the first redundancy version in the sequence is from the first set of redundancy versions. Further, the first RV in the sequence only appears once in the sequence so as to avoid overlap of RVs for initial transmission and RVs for retransmission. The rest of RVs other than the first one in the sequence are used for retransmission. For example, the apparatus 320 may configure a RV sequence of length n, where n is a positive integer number. A TB may be sequentially transmitted n times with RV in the RV sequence. The first RV member (used for initial transmission) needs to be self-decodable. The apparatus 310 may process HARQ in the same way by using the first element of the RV sequence as the only member of the first set of RVs.

The configuration of RV may be HARQ process specific. For example, the configuration of RV may be configured per HARQ process based on a requirement of data service. Different configurations of RV may be applied to different HARQ processes. For example, the configuration of RV may indicate the RV sequence {RV0, RV2, RV3} for HARQ process 1 and the RV sequence {RV0} for HARQ process 2. Alternatively, the configuration of RV may indicate the first set of RVs including {RV0} and the second set of RVs including {RV1, RV2, RV3} for the HARQ process 1. In this case, the configuration of RV may further indicate the first set of RVs including {RV0, RV3} and the second set of RVs including {RV1, RV2} for the HARQ process 2.

The apparatus 320 transmits (3030) downlink control information (DCI) to the apparatus 310. The DCI schedules data. For example, the DCI may schedule downlink data transmission on PDSCH. Alternatively, the DCI may schedule uplink data transmission on PUSCH. The DCI comprises a new data indicator (NDI) and a RV. In some example embodiments, after transmitting the DCI, the apparatus 320 may update the stored new data indicator as the new data indicator in the DCI.

The apparatus 310 determines (3040) whether the scheduled data is an initial transmission or a retransmission based on the NDI and the RV. In some example embodiments, if the new data indicator is the DCI is different from a stored new data indicator, the apparatus 310 may determine that the scheduled data is the initial transmission of the data. For example, if the new data indicator in the DCI is “1” and the stored new data indicator is “0”, the scheduled data is determined as the initial transmission of the data. Alternatively, or in addition, if the RV in the DCI is from the first set of RVs, the apparatus 310 may determine that the scheduled data is the initial transmission of the data. For example, if the first set of RVs includes RV0 and the DCI indicates RV0, the scheduled data is determined as the initial transmission of the data even if the new data indicator in the DCI appears untoggled (same as the stored new data indicator).

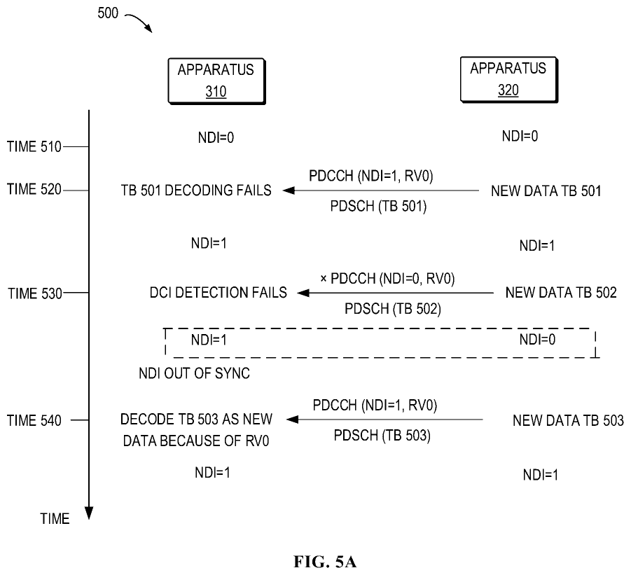

FIG. 5A illustrates a schematic diagram 500 of new data transmission after NDI state becomes out of synchronization according to some example embodiments of the present disclosure. In FIG. 5A, the first set of RVs includes RV0, and the second set of RVs includes RV1, RV2, and RV3. At time 510, the NDI state at the apparatus 310 is 0 and the NDI state at the apparatus 320 is 0. At time 520, if a new data TB 501 is to be transmitted, the apparatus 320 transmits a DCI that indicates NDI=1 and RV0 on PDCCH to the apparatus 310. The NDI state at the apparatus 320 is updated to 1. The DCI schedules the TB 501 transmitted on PDSCH. The apparatus 320 transmits the TB 501 on PDSCH. The apparatus 310 fails to decode the TB 501. The NDI state at the apparatus 310 is updated to 1. At time 530, if a new data TB 502 is to be transmitted, the apparatus 320 transmits a DCI that indicates NDI=0 and RV0 on PDCCH to the apparatus 310. The DCI schedules the TB 502 transmitted on PDSCH. The apparatus 310 fails to decode the DCI. In this case, the NDI state at the apparatus 310 remains 1 and the NDI state at the apparatus 320 is changed to 0, which means the NDI states at the apparatus 310 and the apparatus 320 are out of synchronization. At time 540, if a new data TB 503 is to be transmitted, the apparatus 320 transmits a DCI that indicates NDI=1 and RV0 on PDCCH to the apparatus 310. In other words, the apparatus 320 may use RV0 for a new TB (i.e., TB 503) in addition to toggling the NDI in the DCI. With redundancy reversion RV0 indicated by the DCI, the apparatus 310 knows this transmission is a new data (i.e., initial transmission) since RV0 belongs to the first set of RVs. Since the NDI is the same as the HARQ process's NDI state, the apparatus 310 is also aware of having missed a DCI with a toggled NDI. In this case, the apparatus 310 may decode the TB 503 transmitted on PDSCH as new data. For example, the apparatus 310 may flush the soft buffer of this HARQ process and decode the TB 503 as new data.

FIG. 5B illustrates a schematic diagram of a data retransmission after NDI becomes out of synchronization according to some example embodiments of the present disclosure. In FIG. 5B, the first set of RVs includes RV0, and the second set of RVs includes RV1, RV2, and RV3. At time 521, the NDI state at the apparatus 310 is 0 and the NDI state at the apparatus 320 is 0. At time 522, if a new data TB 511 is to be transmitted, the apparatus 320 transmits a DCI that indicates NDI=1 and RV0 on PDCCH to the apparatus 310. The DCI schedules the TB 511 transmitted on PDSCH. The apparatus 320 transmits the TB 511 with RV0 on PDSCH. The apparatus 310 fails to decode the TB 511. The NDI state at the apparatus 310 is updated to 1 and the NDI state at the apparatus 320 is updated to 1. At time 523, if a new data TB 512 is to be transmitted, the apparatus 320 transmits a DCI that indicates NDI=0 and RV0 on PDCCH to the apparatus 310. The DCI schedules the TB 512 transmitted on PDSCH. The apparatus 320 transmits the TB 512 with RV0 on PDSCH. The apparatus 310 fails to decode the DCI. In this case, the NDI state at the apparatus 310 remains to be 1 and the NDI state at the apparatus 320 is updated to 0, which means the NDI states at the apparatus 310 and the apparatus 320 are out of synchronization. At time 524, the apparatus 320 transmits the TB 512 with RV2 on the PDSCH. In other words, the TB 512 is retransmitted, after NDI state becomes out of synchronization between the apparatus 310 and the apparatus 320 when the apparatus 310 is expecting a retransmission of TB 511. However, the NDI (NDI=0) in the DCI is different from the NDI state (NDI=1) of the HARQ process, so the apparatus 310 may recognize this transmission is not for TB 511. Since the redundancy version in the DCI is RV2 which belongs to the second set of RVs, the apparatus 310 knows it is a retransmission for a new TB, and that it has missed a DCI when the NDI was toggled. As a result, the apparatus 310 may flush the soft buffer of this HARQ process and save the soft bits of TB 512 from this transmission to the soft buffer. Since RV2 used in this transmission is not self-decodable, the apparatus 310 does not need to attempt decoding the TB, but just keep the received soft bits in the soft buffer to be combined with the next retransmission of TB 512. If the retransmission at time 524 uses RV3, on the other hand, the apparatus 310 may decode it as new data since RV3 is self-decodable.

As mentioned above, the configuration of RV may indicate a fixed RV pattern for a fixed number of transmissions. For example, the apparatus 320 may configure a RV sequence={RV0, RV2, RV3} for three transmissions for each TB. In this case, every TB may be transmitted sequentially with RV0 for the initial transmission and with RV2 and RV3 for retransmissions. The length of RV sequence therefore defines the number of transmissions for a TB. A special case is when the sequence has only one element, which essentially disables retransmission. In this solution, the RV used for the initial transmission cannot be used for retransmission. In other words, the first element in the RV sequence cannot appear again later in the RV sequence. The apparatus 310 may follow the same procedure to identify new data or retransmission for HARQ based on NDI and RV with the knowledge of RV for the initial transmission. If network expects a deep fade during the connection, it may use a self-decodable RV early for retransmission. For example, as shown in FIG. 5B, the apparatus 320 may use self-decodable RV3 for the first retransmission at time 540. That allows the possibility of TB 502 being decoded after the failure of the initial transmission. Likewise, a self-decodable RV can be placed earlier in the sequence of RV pattern for retransmission, e.g., {RV0, RV3, RV2}.

Referring back to FIG. 3, the apparatus 310 processes (3060) the data based on the determination. For example, as mentioned above, the data scheduled by the DCI (received at 3030) may be downlink data. In this case, in some example embodiments, the apparatus 320 may transmit (3050) the data to the apparatus 310. In other words, the apparatus 310 receives the data from the apparatus 320. If the data is the initial transmission of the data, the apparatus 310 may flush the data to a buffer and decode the new data. Alternatively, if the data is a retransmission, the apparatus 310 may combine the received data with a previous reception of the data. The apparatus 310 may decode the combined dat.

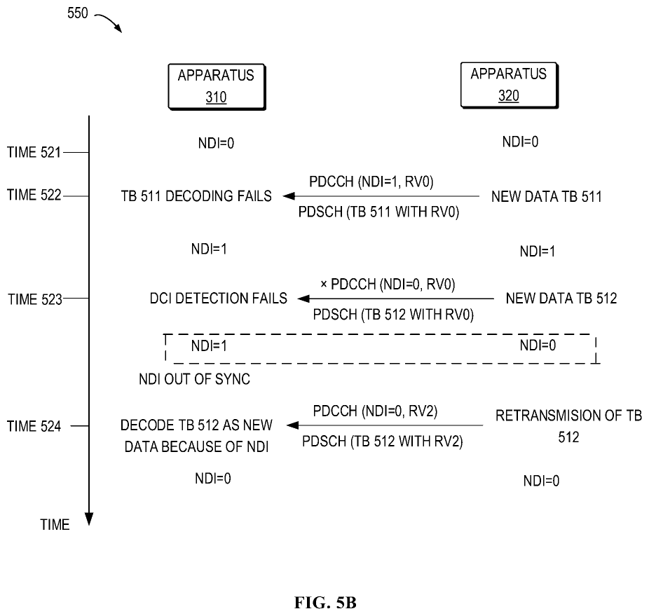

For example, FIG. 6A illustrates a flowchart 600 of a DL HARQ processing the apparatus 310 according to some example embodiments of the present disclosure. As shown in FIG. 6A, at block 610, the apparatus 310 may obtain the configuration of RV. At block 620, the apparatus 310 may receive the DCI that schedules data and comprises a NDI and a RV. Details of obtaining (610) the configuration of RV and the reception (620) of DCI are omitted, since the details are similar as obtaining (3020) the configuration of RV and the reception (3030) of DCI shown in FIG. 3. At block 630, for the DL HARQ process i, the apparatus 310 may determine whether the NDI in the DCI is same as the NDI state. If the NDI is different from the NDI state, at block 650, the apparatus 310 may flush the data to the buffer. If the NDI is same as the NDI state, at block 640, the apparatus 310 may determine whether the RV in the DCI is an initial transmission RV. If the RV is the initial transmission RV, at block 650, the apparatus 310 may flush the data to the buffer. The apparatus 310 may decode, at block 670, the data. If the RV is not the initial transmission RV, at block 660, the apparatus 310 may combine the data with previous data. In this case, the apparatus 310 may decode, at block 670, the combined data. At block 680, the apparatus 310 may update the stored NDI state as the NDI in the DCI.

Alternatively, as mentioned above, the data scheduled by the DCI (received at 3030) may be uplink data. In some example embodiments, the data may be the initial transmission. In this case, the apparatus 310 may encode the new uplink data. The apparatus 310 may transmit (3070) the encoded data to the apparatus 320. Alternatively, the data may be the retransmission. In this case, the apparatus 310 may obtain encoded bits of the RV. The apparatus 310 may transmit (3070) the encoded bits to the apparatus 320.

For example, FIG. 6B illustrates a flowchart 601 of an UL HARQ processing the apparatus 310 according to some example embodiments of the present disclosure. As shown in FIG. 6B, at block 611, the apparatus 310 may obtain the configuration of RV. At block 621, the apparatus 310 may receive the DCI that schedules data and comprises a NDI and a RV. Details of obtaining (611) the configuration of RV and the reception (621) of DCI are omitted, since the details are similar as obtaining (3020) the configuration of RV and the reception (3030) of DCI shown in FIG. 3. At block 631, for the UL HARQ process i, the apparatus 310 may determine whether the NDI in the DCI is same as the NDI state. If the NDI is different from the NDI state, at block 651, the apparatus 310 may encode the new data. If the NDI is same as the NDI state, at block 641, the apparatus 310 may determine whether the RV in the DCI is the initial transmission RV. If the RV is the initial transmission RV, at block 651, the apparatus 310 may encode the new data. The apparatus 310 may transmit, at block 671, the encoded data. If the RV is not the initial transmission RV, at block 661, the apparatus 310 may obtain encoded bits of the RV. In this case, the apparatus 310 may transmit, at block 671, the encoded bits of the RV. At block 681, the apparatus 310 may update the stored NDI state as the NDI in the DCI.

In some example embodiments, the apparatus 310 may update the stored NDI state as the new data indicator in the downlink control information. The stored NDI state may be per HARQ process, i.e., each HARQ process has an independently stored NDI state. The decoding and transmission of data may also be per HARQ process. Each HARQ process can operate independently.

According to embodiments described with reference to FIG. 3, it proposes a mechanism to guard against subsequent packet error arising from a DCI detection failure when HARQ feedback is disabled. Subsequent packet error can be avoided for DL/UL transmissions after the NDI state becomes out of sync.

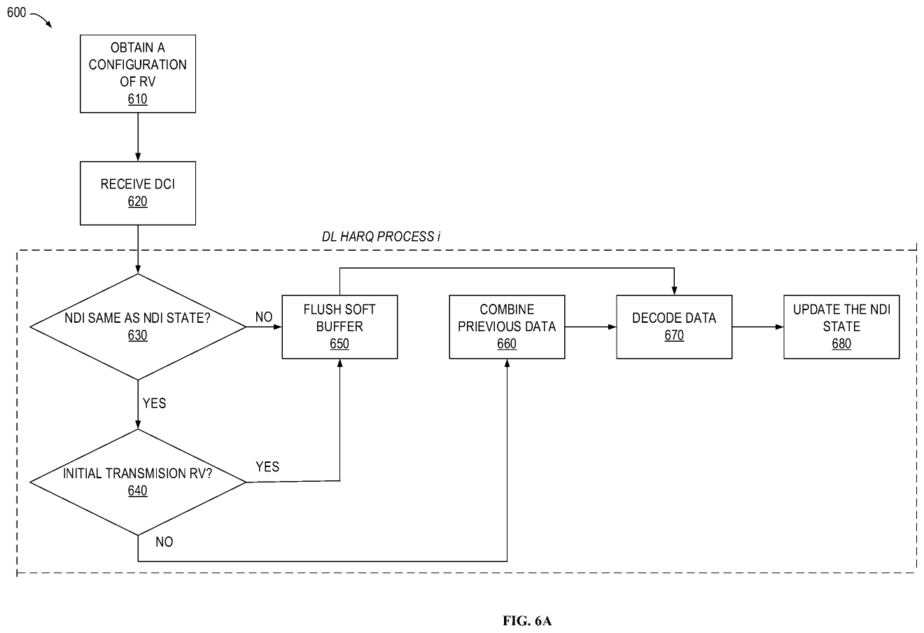

FIG. 7 shows a flowchart of an example method 700 implemented at a first device in accordance with some example embodiments of the present disclosure. For the purpose of discussion, the method 700 will be described from the perspective of the device 110 in FIG. 2.

At block 710, the device 110 obtains a configuration of redundancy version. The configuration of redundancy version indicates a first set of redundancy versions used for an initial data transmission and a second set of redundancy versions used for a data retransmission. In some example embodiments, the device 110 may receive the configuration of redundancy version from the second device. In some example embodiments, the configuration of redundancy version is preconfigured at the first device.

At block 720, the device 110 receives, from a second device (for example, the device 120), downlink control information. The downlink control information schedules data and comprises a new data indicator and a redundancy version for the data.

At block 730, the device 110 determines, based on the new data indicator and the redundancy version, whether the scheduled data is an initial transmission of the data or a retransmission of the data. In some example embodiments, the device 110 may determine that the scheduled data is the initial transmission of the data, if the following is satisfied: the new data indicator in the downlink control information is different from a stored new data indicator, or the new data indicator in the downlink control information is same as the stored new data indicator and the redundancy version in the downlink control information is from the first set of redundancy versions.

At block 740, the device 110 processes the data based on the determination. In some example embodiments, the data scheduled by the downlink control information is new downlink data. In this case, the device 110 may receive the data from the second device; flushing the data to a buffer; and decoding the data. In some example embodiments, the data scheduled by the down link control information is new uplink data. In this case, the device 110 may encode the new uplink data and transmit the encoded new uplink data to the second device.

In some example embodiments, if the new data indicator in the downlink control information is same as a stored new data indicator and the redundancy version in the downlink control information is from the second set of redundancy versions, the device 110 may determine that the scheduled data is the retransmission of previous data. In some example embodiments, the data scheduled by the downlink control information is downlink data retransmission. In this case, the device 110 may receive the data from the second device; combining the data with a previous reception of the data; and decoding the combined data. In some example embodiments, the data scheduled by the downlink control information is uplink data retransmission. In this case, the device 110 may obtain encoded bits of the redundancy version and transmit the encoded bits to the second device.

In some example embodiments, the device 110 may update the stored new data indicator as the new data indicator in the downlink control information. In some example embodiments, the configuration of redundancy version comprises a sequence of the redundancy versions. In this case, a first redundancy version in the sequence is from the first set of redundancy versions. In some example embodiments, the configuration of redundancy version is configured per hybrid automatic repeat request process based on a requirement of data service.

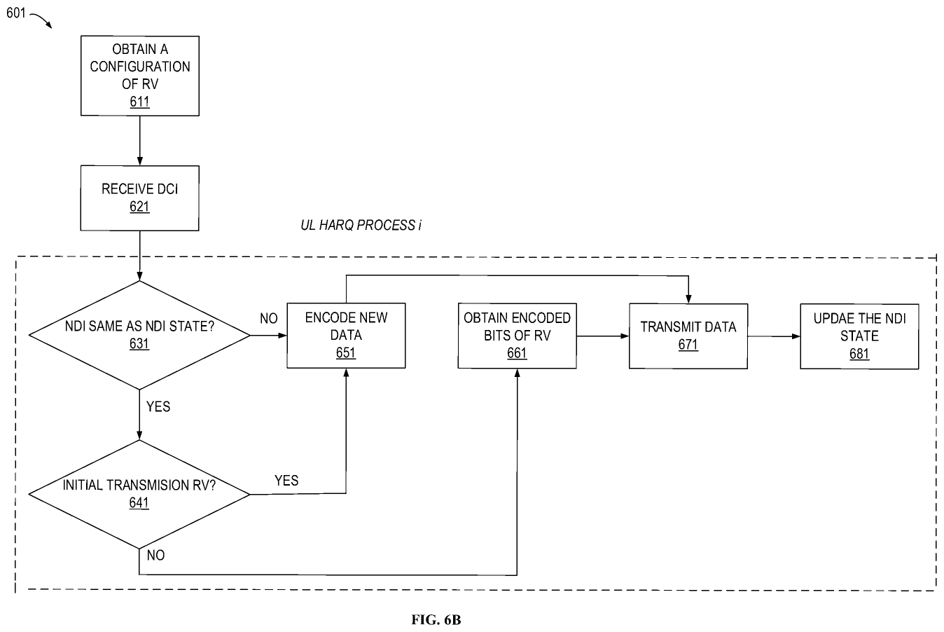

FIG. 8 shows a flowchart of an example method 800 implemented at a second device in accordance with some example embodiments of the present disclosure. For the purpose of discussion, the method 800 will be described from the perspective of the device 120 in FIG. 2.

At block 810, the device 120 obtains a configuration of redundancy version. The redundancy version indicates a first set of redundancy versions used for an initial data transmission and a second set of redundancy versions used for a data retransmission.

At block 820, the device 120 transmits to a first device (for example, the device 110), downlink control information that schedules data and comprises a new data indicator and a redundancy version for the data. Whether the scheduled data is an initial transmission of the data, or a retransmission of the data is indicated with a combination of the new data indicator and the redundancy version.

In some example embodiments, the scheduled data is the initial transmission of the data, if the following is satisfied: the new data indicator in the downlink control information is different from a stored new data indicator, or the new data indicator in the downlink control information is the same as the stored new data indicator and the redundancy version in the downlink control information is from the first set of redundancy versions. In some example embodiments, the scheduled data is the retransmission of the data, in accordance with a determination that the new data indicator in the downlink control information is same as a stored new data indicator and a determination that the redundancy version in the downlink control information is from the second set of redundancy versions.

In some example embodiments, the configuration of redundancy version comprises a sequence of the redundancy versions. In this case, a first redundancy version in the sequence is from the first set of redundancy versions. In some example embodiments, the configuration of redundancy version is configured per hybrid automatic repeat request process based on a requirement of data service.

In some example embodiments, a first apparatus capable of performing any of the method 700 (for example, the device 110 in FIG. 2) may comprise means for performing the respective operations of the method 700. The means may be implemented in any suitable form. For example, the means may be implemented in a circuitry or software module. The first apparatus may be implemented as or included in the first device 110 in FIG. 2.

In some example embodiments, the first apparatus comprises means for obtaining a configuration of redundancy version that indicates a first set of redundancy versions used for an initial data transmission and a second set of redundancy versions used for a data retransmission; means for receiving, from a second device, downlink control information that schedules data and comprises a new data indicator and a redundancy version for the data; means for determining, based on the new data indicator and the redundancy version, whether the scheduled data is an initial transmission of the data or a retransmission of the data; and means for processing the data based on the determination.

In some example embodiments, the first set of redundancy versions does not overlap with the second set of redundancy versions; and each redundancy version in the first set of redundancy versions is self-decodable.

In some example embodiments, the first apparatus comprises means for receiving the configuration of redundancy version from the second device.

In some example embodiments, the configuration of redundancy version is preconfigured at the first device.

In some example embodiments, the first apparatus comprises means for determining that the scheduled data is the initial transmission of the data, in accordance with a determination that the following is satisfied: the new data indicator in the downlink control information is different from a stored new data indicator, or the new data indicator in the downlink control information is the same as the stored new data indicator and the redundancy version in the downlink control information is from the first set of redundancy versions.

In some example embodiments, the data scheduled by the downlink control information is new downlink data, and wherein the first apparatus comprises means for receiving the data from the second device; means for flushing the data to a buffer; and means for decoding the data.

In some example embodiments, the data scheduled by the down link control information is new uplink data, and the first apparatus comprises means for encoding the new uplink data; and transmit the encoded new uplink data to the second device.

In some example embodiments, the first apparatus comprises means for in accordance with a determination that the new data indicator in the downlink control information is same as a stored new data indicator and a determination that the redundancy version in the downlink control information is from the second set of redundancy versions, determining that the scheduled data is the retransmission of previous data.

In some example embodiments, the data scheduled by the downlink control information is downlink data retransmission, and the first apparatus comprises means for receiving the data from the second device; means for combining the data with a previous transmission of the data; and means for decoding the combined data.

In some example embodiments, the data scheduled by the downlink control information is uplink data retransmission, and the first apparatus comprises means for obtaining encoded bits of the redundancy version; and means for transmitting the encoded bits to the second device.

In some example embodiments, the first apparatus comprises means for updating the stored new data indicator as the new data indicator in the downlink control information.

In some example embodiments, the configuration of redundancy version comprises a sequence of the redundancy versions, and wherein a first redundancy version in the sequence is from the first set of redundancy versions.

In some example embodiments, the configuration of redundancy version is configured per hybrid automatic repeat request process based on a requirement of data service.

In some example embodiments, the first device comprises a terminal device, and the second device comprises a network device.

In some example embodiments, the first apparatus further comprises means for performing other operations in some example embodiments of the method 700 or the device 110. In some example embodiments, the means comprises at least one processor; and at least one memory storing instructions that, when executed by the at least one processor, cause the performance of the first apparatus.

In some example embodiments, a second apparatus capable of performing any of the method 800 (for example, the device 120 in FIG. 2) may comprise means for performing the respective operations of the method 800. The means may be implemented in any suitable form. For example, the means may be implemented in a circuitry or software module. The second apparatus may be implemented as or included in the second device 120 in FIG. 2.

In some example embodiments, the second apparatus comprises means for obtaining a configuration of redundancy version that indicates a first set of redundancy versions used for an initial data transmission and a second set of redundancy versions used for a data retransmission; and means for transmitting, to a first device, downlink control information that schedules data and comprises a new data indicator and a redundancy version for the data, wherein whether the scheduled data is an initial transmission of the data or a retransmission of the data is indicated with a combination of the new data indicator and the redundancy version.

In some example embodiments, the scheduled data is the initial transmission of the data, in accordance with a determination that the following is satisfied: the new data indicator in the downlink control information is different from a stored new data indicator, or the redundancy version in the downlink control information is from the first set of redundancy versions.

In some example embodiments, the scheduled data is the retransmission of the data, in accordance with a determination that the new data indicator in the downlink control information is same as a stored new data indicator and a determination that the redundancy version in the downlink control information is from the second set of redundancy versions.

In some example embodiments, the second apparatus comprises means for updating the stored new data indicator as the new data indicator in the downlink control information.

In some example embodiments, the configuration of redundancy version comprises a sequence of the redundancy versions, and wherein a first redundancy version in the sequence is from the first set of redundancy versions.

In some example embodiments, the configuration of redundancy version is configured per hybrid automatic repeat request process based on a requirement of data service.

In some example embodiments, the first device comprises a terminal device, and the second device comprises a network device.

In some example embodiments, the second apparatus further comprises means for performing other operations in some example embodiments of the method 800 or the device 120. In some example embodiments, the means comprises at least one processor; and at least one memory storing instructions that, when executed by the at least one processor, cause the performance of the second apparatus.

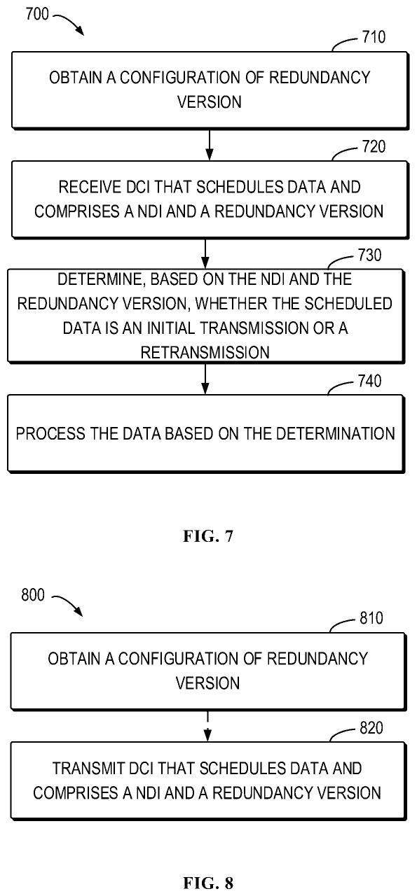

FIG. 9 is a simplified block diagram of a device 900 that is suitable for implementing example embodiments of the present disclosure. The device 900 may be provided to implement a communication device, for example, the device 110 or the device 120 as shown in FIG. 2. As shown, the device 900 includes one or more processors 910, one or more memories 920 coupled to the processor 910, and one or more communication modules 940 coupled to the processor 910.

The communication module 940 is for bidirectional communications. The communication module 940 has one or more communication interfaces to facilitate communication with one or more other modules or devices. The communication interfaces may represent any interface that is necessary for communication with other network elements. In some example embodiments, the communication module 940 may include at least one antenna.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random-access memory (RAM) 922 and other volatile memories that will not last in the power-down duration.

A computer program 930 includes computer executable instructions that are executed by the associated processor 910. The instructions of the program 930 may include instructions for performing operations/acts of some example embodiments of the present disclosure. The program 930 may be stored in the memory, e.g., the ROM 924. The processor 910 may perform any suitable actions and processing by loading the program 930 into the RAM 922.

The example embodiments of the present disclosure may be implemented by means of the program 930 so that the device 900 may perform any process of the disclosure as discussed with reference to FIG. 2 to FIG. 8. The example embodiments of the present disclosure may also be implemented by hardware or by a combination of software and hardware.

In some example embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

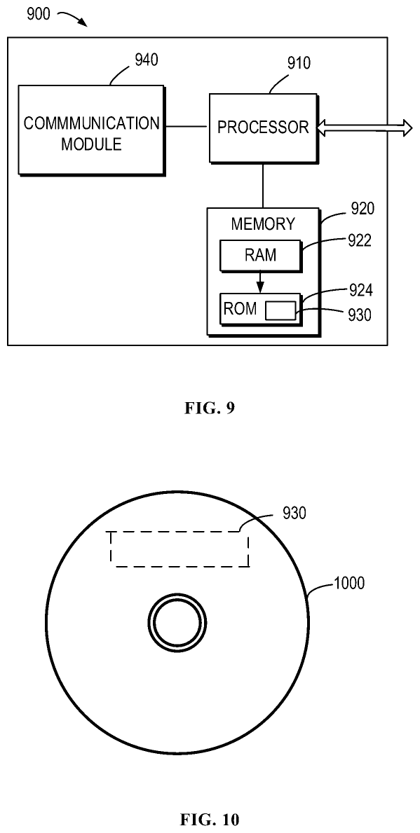

FIG. 10 shows an example of the computer readable medium 1000 which may be in form of CD, DVD or other optical storage disk. The computer readable medium 1000 has the program 930 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general-purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A first apparatus comprising:
at least one processor; and
at least one memory storing instructions that, when executed by the at least one processor, cause the first apparatus to perform:
obtaining a configuration of redundancy version that indicates a first set of redundancy versions used for an initial data transmission and a second set of redundancy versions used for a data retransmission;
receiving, from a second apparatus, downlink control information that schedules data and comprises a new data indicator and a redundancy version for the data;
determining, based on the new data indicator and the redundancy version, whether the scheduled data is an initial transmission of the data or a retransmission of the data; and
processing the data based on the determination.

2. The first apparatus of claim 1, wherein the first set of redundancy versions does not overlap with the second set of redundancy versions; and
each redundancy version in the first set of redundancy versions is self-decodable.

3. The first apparatus of claim 1 or 2, wherein the instructions, when executed by the at least one processor, cause the first apparatus to perform:
receiving the configuration of redundancy version from the second apparatus.

4. The first apparatus of claim 1 or 2, wherein the configuration of redundancy version is preconfigured at the first apparatus.

5. The first apparatus of any preceding claim, wherein the instructions, when executed by the at least one processor, cause the first apparatus to perform:
determining that the scheduled data is the initial transmission of the data, in accordance with a determination that the following is satisfied:
the new data indicator in the downlink control information is different from a stored new data indicator, or
the new data indicator in the downlink control information is the same as the stored new data indicator and the redundancy version in the downlink control information is from the first set of redundancy versions.

6. The first apparatus of claim 5, wherein the data scheduled by the downlink control information is new downlink data, and wherein the instructions, when executed by the at least one processor, cause the first apparatus to perform:
receiving the data from the second apparatus;
flushing the data to a buffer; and
decoding the data.

7. The first apparatus of claim 5, wherein the data scheduled by the down link control information is new uplink data, and wherein the instructions, when executed by the at least one processor, cause the first apparatus to perform:
encoding the data; and
transmit the encoded data to the second apparatus.

8. The first apparatus of any preceding claim 1 to 4, wherein the instructions, when executed by the at least one processor, cause the first apparatus to perform:
in accordance with a determination that the new data indicator in the downlink control information is same as a stored new data indicator and a determination that the redundancy version in the downlink control information is from the second set of redundancy versions, determining that the scheduled data is the retransmission of previous data.

9. The first apparatus of claim 8, wherein the data scheduled by the downlink control information is downlink data retransmission, and wherein the instructions, when executed by the at least one processor, cause the first apparatus to perform:
receiving the data from the second apparatus;
combining the data with a previous transmission of the data; and
decoding the combined data.

10. The first apparatus of claim 8, wherein the data scheduled by the downlink control information is uplink data retransmission, and wherein the instructions, when executed by the at least one processor, cause the first apparatus to perform:
obtaining encoded bits of the redundancy version; and
transmitting the encoded bits to the second apparatus.

11. The first apparatus of any preceding claim, wherein the instructions, when executed by the at least one processor, cause the first apparatus to perform:
updating the stored new data indicator as the new data indicator in the downlink control information.

12. The first apparatus of any preceding claim, wherein the configuration of redundancy version comprises a sequence of the redundancy versions, and wherein a first redundancy version in the sequence is from the first set of redundancy versions.

13. The first apparatus of any preceding claim, wherein the configuration of redundancy version is configured per hybrid automatic repeat request process based on a requirement of data service.

14. The first apparatus of any preceding claim, wherein the first apparatus comprises a terminal device, and the second apparatus comprises a network device.

15. A second apparatus comprising:
at least one processor; and
at least one memory storing instructions that, when executed by the at least one processor, cause the second apparatus to perform:
obtaining a configuration of redundancy version that indicates a first set of redundancy versions used for an initial data transmission and a second set of redundancy versions used for a data retransmission; and
transmitting, to a first apparatus, downlink control information that schedules data and comprises a new data indicator and a redundancy version for the data, wherein whether the scheduled data is an initial transmission of the data or a retransmission of the data is indicated with a combination of the new data indicator and the redundancy version.

16. The second apparatus of claim 15, wherein the first set of redundancy versions does not overlap with the second set of redundancy versions; and
each redundancy version in the first set of redundancy versions is self-decodable.

17. The second apparatus of claim 15, wherein the scheduled data is the initial transmission of the data, in accordance with a determination that the following is satisfied:
the new data indicator in the downlink control information is different from a stored new data indicator, or
the new data indicator in the downlink control information is the same as the stored new data indicator and the redundancy version in the downlink control information is from the first set of redundancy versions.

18. The second apparatus of claim 15, wherein the scheduled data is the retransmission of the data, in accordance with a determination that the new data indicator in the downlink control information is same as a stored new data indicator and a determination that the redundancy version in the downlink control information is from the second set of redundancy versions.

19. The second apparatus of any preceding claim, wherein the instructions, when executed by the at least one processor, cause the second apparatus to perform:
after transmitting the downlink control information, updating the stored new data indicator as the new data indicator in the downlink control information.

20. The second apparatus of any preceding claim, wherein the configuration of redundancy version comprises a sequence of the redundancy versions, and wherein a first redundancy version in the sequence is from the first set of redundancy versions.

21. The second apparatus of any preceding claim, wherein the configuration of redundancy version is configured per hybrid automatic repeat request process based on a requirement of data service.

22. The second apparatus of any preceding claim, wherein the first apparatus comprises a terminal device, and the second apparatus comprises a network device.

23. A method, comprising:
obtaining, by a first apparatus, a configuration of redundancy version that indicates a first set of redundancy versions used for an initial data transmission and a second set of redundancy versions used for a data retransmission;
receiving, from a second apparatus, downlink control information that schedules data and comprises a new data indicator and a redundancy version for the data;
determining, based on the new data indicator and the redundancy version, whether the scheduled data is an initial transmission of the data or a retransmission of the data; and
processing the data based on the determination.

24. A method, comprising:
obtaining, by a second apparatus, a configuration of redundancy version that indicates a first set of redundancy versions used for an initial data transmission and a second set of redundancy versions used for a data retransmission; and
transmitting, to a first apparatus, downlink control information that schedules data and comprises a new data indicator and a redundancy version for the data, wherein whether the scheduled data is an initial transmission of the data or a retransmission of the data is indicated with a combination of the new data indicator and the redundancy version.

25. A non-transitory computer readable medium comprising program instructions that, when executed by a first apparatus, cause the first apparatus to perform at least the following:
obtaining a configuration of redundancy version that indicates a first set of redundancy versions used for an initial data transmission and a second set of redundancy versions used for a data retransmission;
receiving, from a second apparatus, downlink control information that schedules data and comprises a new data indicator and a redundancy version for the data;
determining, based on the new data indicator and the redundancy version, whether the scheduled data is an initial transmission of the data or a retransmission of the data; and
processing the data based on the determination.

26. A non-transitory computer readable medium comprising program instructions that, when executed by a second apparatus, cause the second apparatus to perform at least the following:
obtaining a configuration of redundancy version that indicates a first set of redundancy versions used for an initial data transmission and a second set of redundancy versions used for a data retransmission; and
transmitting, to a first apparatus, downlink control information that schedules data and comprises a new data indicator and a redundancy version for the data, wherein whether the scheduled data is an initial transmission of the data or a retransmission of the data is indicated with a combination of the new data indicator and the redundancy version.
